(19) United States
(12) Patent Application Publication
(10) Pub. No.: US 2014/0013820 A1
(43) Pub. Date: Jan. 16, 2014

(54) Ported Bushing for a Pressure Switch Housing

(71) Applicant: Kenneth Brad Hillman, Edmonton (CA)

(72) Inventor: Kenneth Brad Hillman, Edmonton (CA)

(21) Appl. No.: 13/937,615

(22) Filed: Jul. 9, 2013

Related U.S. Application Data
(60) Provisional application No. 61/670,026, filed on Jul. 10, 2012.

(51) Int. Cl. F16K 37/00; F16L 41/00

(52) U.S. Cl. CPC F16K 37/0091; F16L 41/005
USPC 73/1.72; 285/129.1

(57) ABSTRACT

A ported bushing for use with a pressure switch for monitoring the pressure of pressurized hydrocarbons flowing through a pipeline is provided, the ported bushing having a main body containing a threaded opening for attaching the pressure switch, two threaded test ports for attaching testing equipment thereto and a threaded end for attaching the ported bushing to a valve attached to the pipeline. The ported bushing can include a tubular body, and can be configured to adapt to different diameters of pressure switches and valves. The ported bushing can further include flattened surfaces for use with a wrench to rotate the bushing. The ported bushing can further include a gauge and a test valve coupled to the test ports to enable the testing of the pressure switch in-situ when the valve is closed.

### PRIORITY STATEMENT & CROSS-REFERENCE TO RELATED APPLICATIONS

This application claims priority from U.S. Patent Application No. 61/670,026, entitled “Ported Bushing for a Pressure Switch Housing” and filed on Jul. 10, 2012 in the name of Kenneth Brad Hillman, which is hereby incorporated by reference herein in its entirety.

### TECHNICAL FIELD OF THE INVENTION

The present disclosure is related to the field of bushings for use with pressure switches for sensing the pressure of hydrocarbons flowing through a pipeline, in particular, ported bushings that allows testing equipment to be attached thereto for testing the operation of the pressure switch.

### BACKGROUND OF THE INVENTION

In pipelines carrying liquid or gas hydrocarbons flowing at high pressure, it is known to use a pressure switch mounted externally to the pipeline to sense the pressure of the fluids or gas flowing through the pipeline. If the pressure of the fluids or gas flowing through the pipeline becomes excessive, the pipeline may burst. A pressure switch can help prevent pipeline ruptures if it is functioning correctly. This can be accomplished by setting a pressure threshold setting on the pressure switch whereupon the pressure of the fluids or gas flowing through pipeline exceed the threshold, the pressure of the fluids can cause the operation of an electrical switch that can further open or close an electrical circuit that can be operatively coupled to other equipment that can lower the pressure of the fluids or gas flowing through the pipeline, as well known skilled in the art. This can be done by slowing down the operation of a pump that is pumping the fluids or gas through the pipeline, or shutting the pump off altogether. Thus, it is extremely important to test pressure switches on a regular basis to ensure that they are functioning properly. In some jurisdictions, government regulations require mandatory periodic testing of pressure switches. In order to accommodate this testing, it is known to mount a pressure switch on an isolator valve, whose function is to isolate the pressure switch from the pipeline, and to run diagnostic tests on the pressure switch without having to remove it and send it to a repair facility.

Current isolator valve designs consist of a ball valve with test ports integral to the valve housing so that a pressure gauge, pressure pump, or other diagnostic tools can be attached to test the functionality of the attached pressure switch. The problem with this type of design is that if any portion of this isolator valve malfunctions, the whole item must be replaced since the test ports are integrated on the valve housing. In order to repair or replace a malfunctioning isolator valve, field personnel must take the corresponding pipeline out of operation, which can result in lost revenues for the pipeline operator.

It is, therefore, desirable to provide a ported bushing for a pressure switch housing that overcomes the shortcomings of prior art designs comprising the aforementioned isolator valves.

### SUMMARY OF THE INVENTION

For the purposes of this specification, the term “valve” shall mean any type of valve as well known to those skilled in the art that can isolate one port or opening from another port or opening, and shall not be limited to any type of valve mechanism that can be used within the valve to provide the means of the isolation function of the valve.

Broadly stated, in some embodiments, a ported bushing is provided for a pressure switch configured for monitoring the pressure of hydrocarbons flowing through a pipeline, the ported bushing comprising: a tubular main body further comprising first and second ends, and a sidewall thereby forming a central passageway between the first and second ends; first attachment means for attaching the pressure switch to the first end; second attachment means for attaching the second end to the pipeline or to a first valve connected to the pipeline; and first and second ports disposed through the sidewall to provide communication to the central passageway, the first and second ports configured to operatively couple with test equipment configured for testing the operation of the pressure switch.

Broadly stated, in some embodiments, the ported bushing can further comprise two flat exterior surfaces at the top of the main body such that a wrench can be used to turn the entire main body.

Broadly stated, in some embodiments, a system is provided for testing a pressure switch configured for monitoring the pressure of hydrocarbons flowing through a pipeline, the system comprising: a ported bushing, further comprising: a tubular main body further comprising first and second ends, and a sidewall thereby forming a central passageway between the first and second ends, first attachment means for attaching the pressure switch to the first end, second attachment means for attaching the second end to a first valve connected to the pipeline, and first and second ports disposed through the sidewall to provide communication to the central passageway, the first and second ports configured to operatively couple with test equipment configured for testing the operation of the pressure switch; a test valve configured for operatively coupling to one of the first and second ports; a pressure gauge configured for operatively coupling to the other of the first and second ports; and the first valve configured for operatively coupling the second end to a tee coupler disposed on the pipeline.

Broadly stated, in some embodiments, the first and second attachment means further comprise threads configured for threadably coupling the main body to the pressure switch and to the pipeline or to the valve, respectively.

Broadly stated, in some embodiments, the main body can further comprise two substantially parallel flattened surfaces disposed on the sidewall of the main body wherein a wrench can engage the flattened surfaces to rotate the main body.

Broadly stated, in some embodiments, the main body can further comprise at least one set screw disposed near the first end, the at least one set screw configured to secure the pressure switch to the main body when the pressure switch is operatively attached to the main body via the first attachment means.

Broadly stated, in some embodiments, the main body can further comprise, or be integrated with, a pressure switch trim.

Broadly stated, in some embodiments, the main body can further comprise, or be integrated with, a pressure switch housing body.

Broadly stated, in some embodiments, a method is provided for testing a pressure switch configured for monitoring the pressure of hydrocarbons flowing through a pipeline comprising a tee coupler disposed thereon, the method comprising the steps of: providing a system for the testing the pressure switch, the system comprising: a ported bushing, further comprising a tubular main body further comprising first and second ends, and a sidewall thereby forming a central passageway between the first and second ends, first attachment means for attaching the pressure switch to the first end, second attachment means for attaching the second end to a first valve connected to the pipeline, and first and second ports disposed through the sidewall to provide communication to the central passageway, the first and second ports configured to operatively couple with test equipment configured for testing the operation of the pressure switch, a test valve configured for operatively coupling to one of the first and second ports, a pressure gauge configured for operatively coupling to the other of the first and second ports, and the first valve configured for operatively coupling the second end to a tee coupler disposed on the pipeline; installing the system between the pressure switch and the tee coupler, wherein: the first valve is operatively coupled to the tee coupler, the ported bushing is operatively coupled to the first valve, the test valve is operatively coupled to one of the of the first and second ports wherein the test valve is in communication with the central passageway, the test valve initially in a closed position, the pressure gauge is operatively coupled to the other of the first and second ports wherein the pressure gauge is in communication with the central passageway, and the pressure switch is operatively coupled to the ported bushing; closing the first valve; attaching a source of gas or fluid that can be pumped to the test valve and opening the test valve; pumping the gas or fluid into the ported bushing wherein the pressure of the gas or fluid in the ported bushing increases until the pressure switch operates; and reading the pressure gauge after the pressure switch operates to obtain a pressure reading displayed thereon.

### BRIEF DESCRIPTION OF THE DRAWINGS

FIG. 1 is a cross-section front elevation view depicting one embodiment of a ported bushing where the ported bushing is integrated with a pressure switch trim.

FIG. 2 is a cross-section side elevation view depicting the ported bushing with integrated pressure switch trim of FIG. 1.

FIG. 3 is a cross-section front elevation view depicting an alternate embodiment of a ported bushing.

FIG. 4 is a cross-section side elevation view depicting the ported bushing of FIG. 3.

FIG. 5 is a partial cross-section side elevation view depicting the ported bushing with integrated pressure switch trim of FIG. 1 connected to a pipeline via a valve and tee connection.

FIG. 6 is a cross-section side elevation view depicting the ported bushing of FIG. 3 connected to a pipeline via a valve and tee connection.

FIG. 7 is a cross-section front elevation view depicting an alternate embodiment of a ported bushing where the ported bushing is integrated with a pressure switch housing body.

FIG. 8 is a cross-section side elevation view depicting the ported pressure switch housing body of FIG. 7.

FIG. 9 is a cross-section side elevation view depicting the ported pressure switch housing body of FIG. 7 connected to a pipeline via a valve and tee connection.

### DETAILED DESCRIPTION OF THE INVENTION

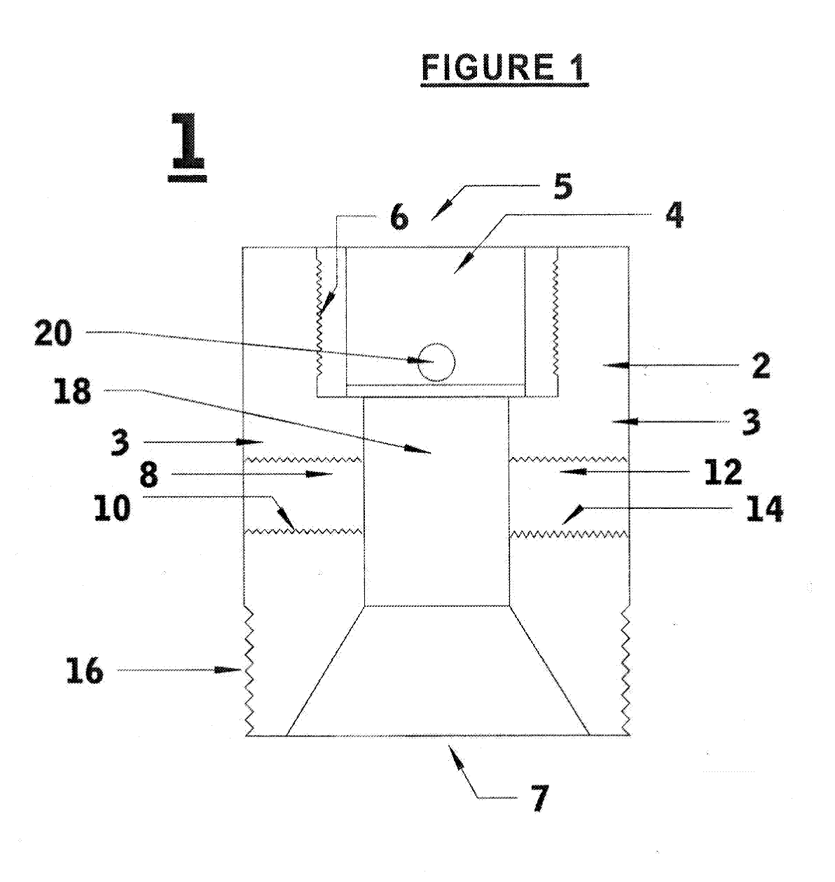

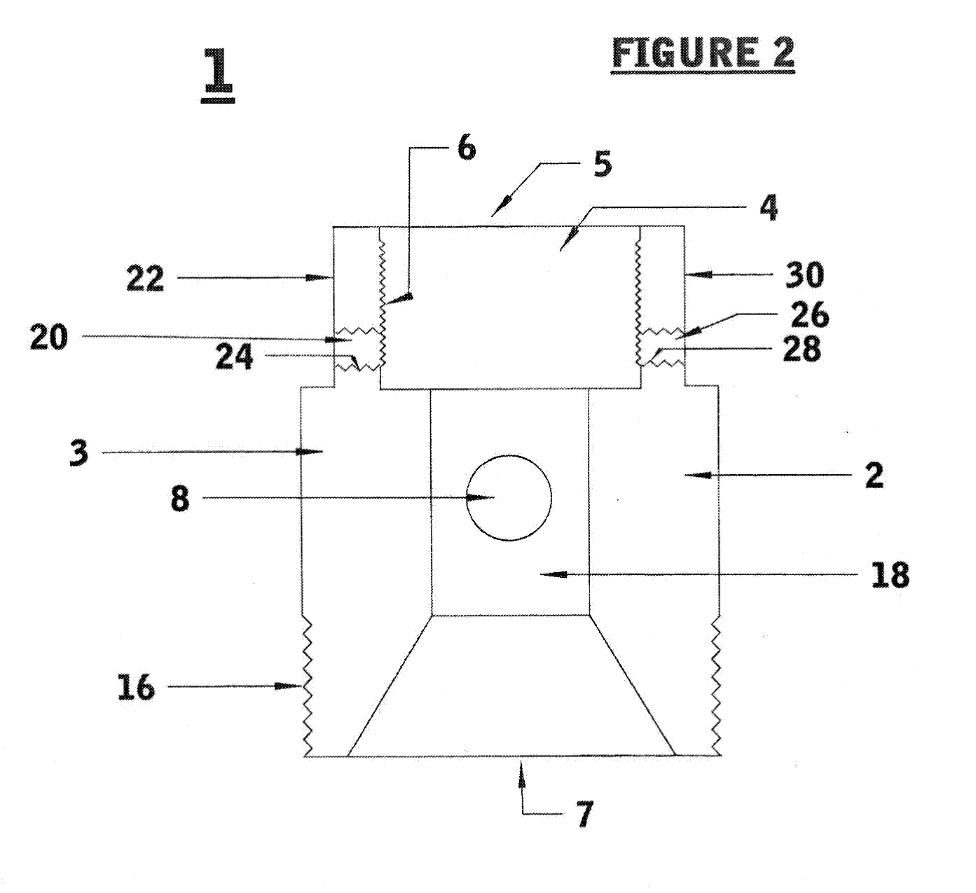

Referring to FIGS. 1 and 2, one embodiment of ported bushing with integrated pressure switch trim 1 is shown. In this embodiment, ported bushing with integrated pressure switch trim 1 can comprise substantially tubular main body 2 having sidewall 3 extending between pressure switch end 5 to valve end 7, thereby forming central passageway 18 extending therebetween. In some embodiments, main body 2 can comprise pressure switch body port 4 for receiving a pressure switch body (not shown) by threading the pressure switch body into threads 6. In some embodiments, ported bushing with integrated pressure switch trim 1 can further comprise at least one set screw holes 20 and 26, having threads 24 and 28, respectively, disposed through sidewall 3 to receive set screws to further secure the pressure switch body in pressure switch body port 4.

In some embodiments, ported bushing with integrated pressure switch trim 1 can further comprise test port 8 and test port 12 extending through sidewall 3 to provide communication with central passageway 18. Test ports 8 and 12 can further comprise threads 10 and 14, respectively. In some embodiments, test ports 8 and 12 can be configured to receive test equipment for testing a pressure switch operatively connected to ported bushing with integrated pressure switch trim 1, as described in more detail below.

In some embodiments, ported bushing with integrated pressure switch trim 1 can comprise end threads 16 disposed on valve end 7 for threading ported bushing with integrated pressure switch trim 1 into a valve (not shown) having a standard-sized threaded opening as well known to those skilled in the art, such as 1 inch, 1½ inch, 2 inch and so on.

In some embodiments, ported bushing with integrated pressure switch trim 1 can further comprise substantially parallel flat surfaces 22 and 30 deposed on main body 2 near pressure switch end 5 for receiving a wrench to turn ported bushing with integrated pressure switch trim 1 into or out of a threaded fitting (not shown) as well known to those skilled in the art.

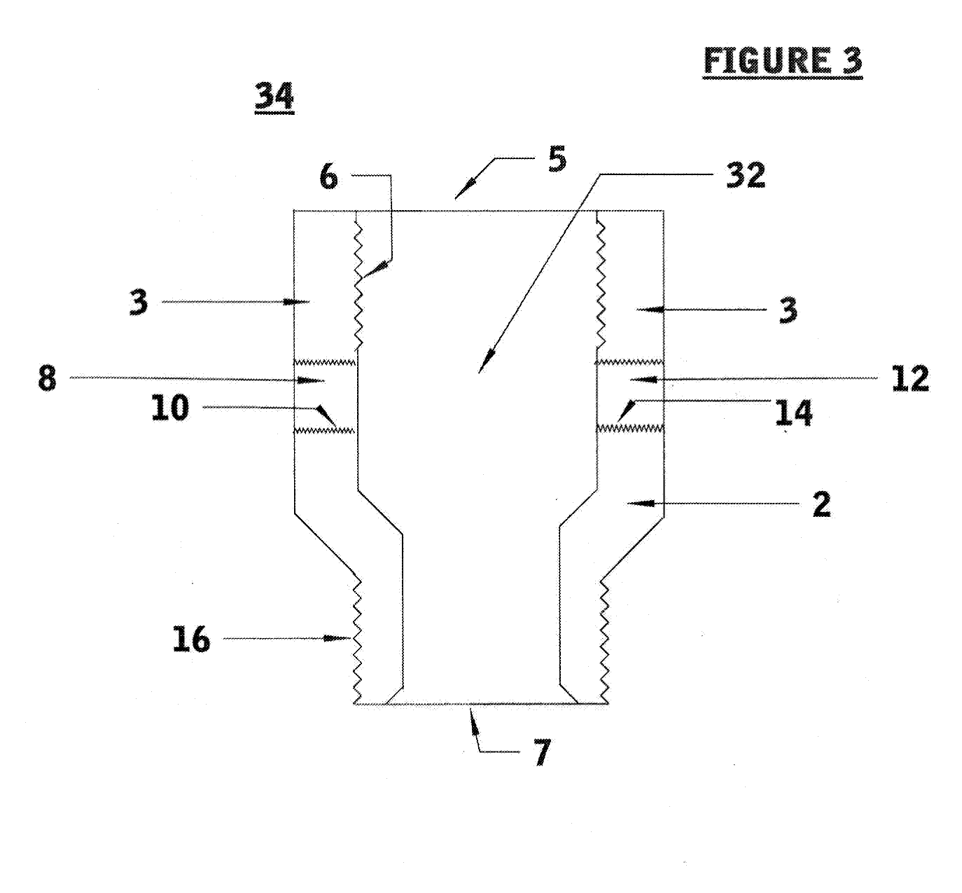

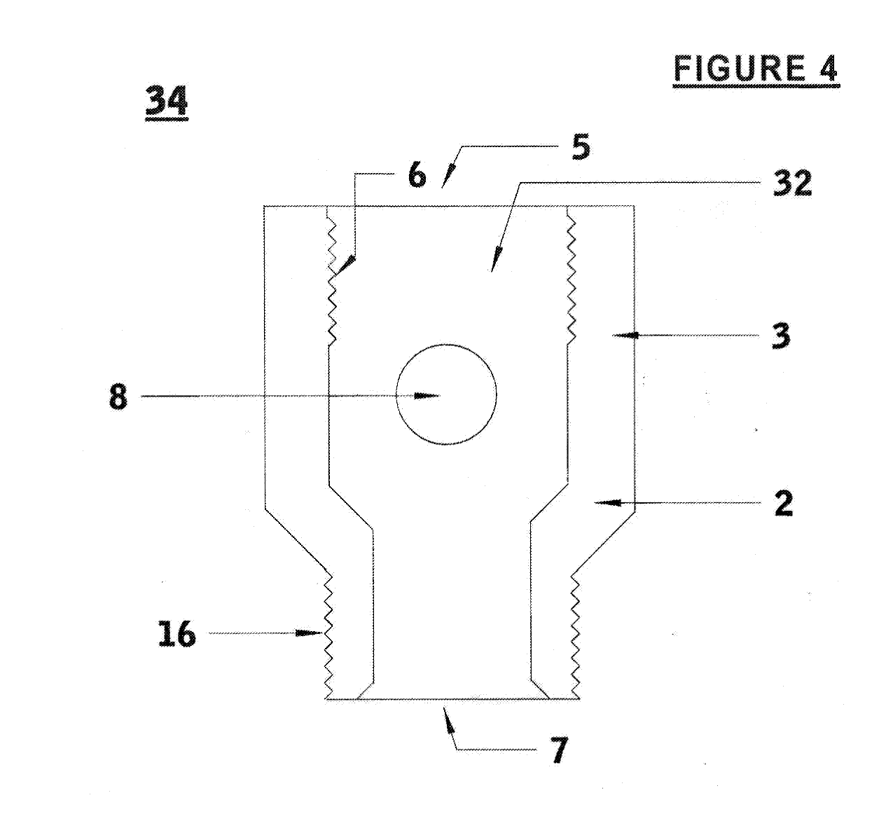

Referring to FIGS. 3 and 4, an alternate embodiment of a ported bushing, represented by reference numeral 34, is shown. In some embodiments, ported bushing 34 can comprise substantially tubular main body 2 having further comprising sidewall 3 extending between pressure switch end 5 and valve end thereby forming central passageway 32 extending therebetween for receiving a pressure switch housing, such as the pressure switch housing illustrated in U.S. Pat. No. 7,351,926 issued 1 Apr. 2008, which is incorporated by reference herein in its entirety, by threading the pressure switch housing into threads 6. In some embodiments, ported bushing 34 can comprise pressure switch end 5 configured as the same size as valve end 7. This can allow ported bushing 34 to be inserted or installed between a pressure switch and a fitting or coupling to which the pressure switch would otherwise be directly coupled to. Similar to the embodiment of ported bushing with integrated pressure switch trim 1 as shown in FIGS. 1 and 2, ported bushing 34 can comprise threads 6 for receiving a pressure switch housing, end threads 16 for coupling to a valve or fitting, and threaded test ports 8 and 12, further comprising threads 10 and 14 respectively, extending through sidewall 3 to provide communication with central passageway 32, and for receiving test equipment to test the operation of a pressure switch coupled to ported bushing 34.

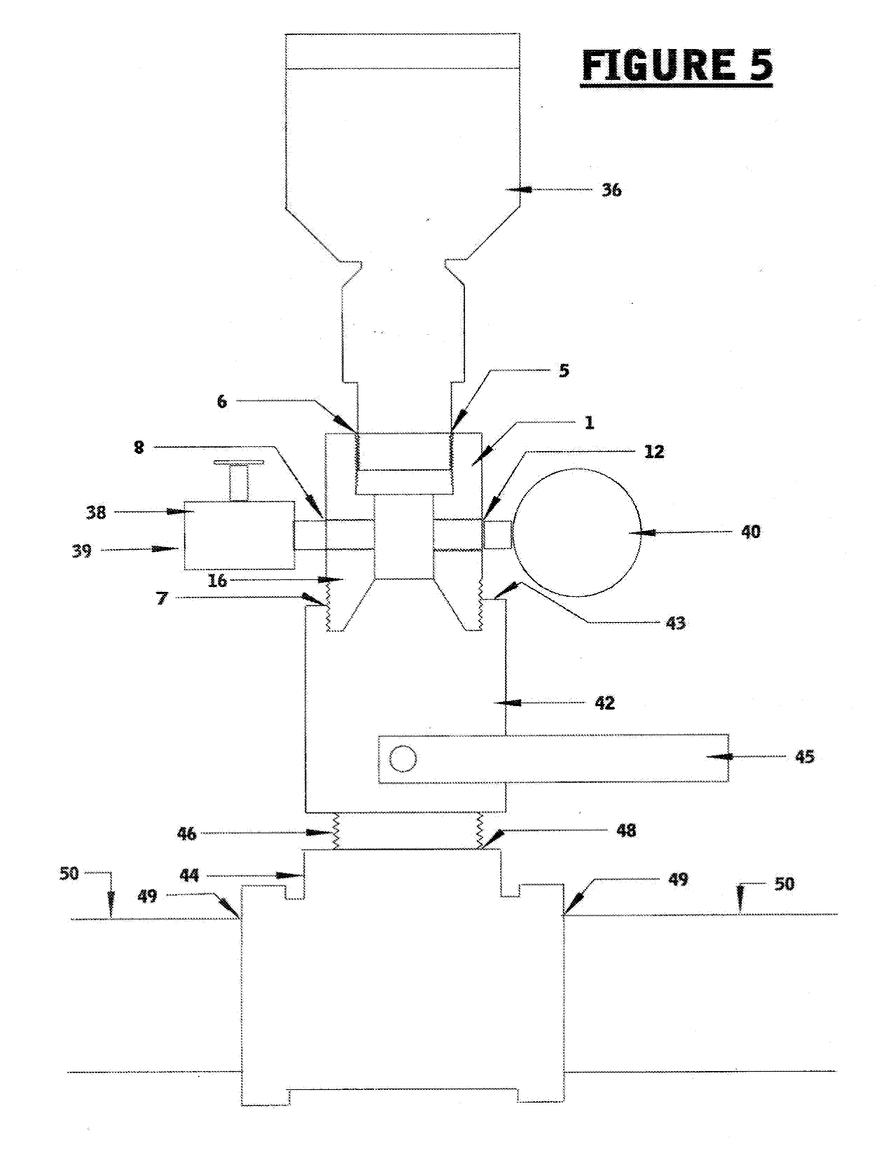

Referring to FIG. 5, an embodiment of how ported bushing with integrated pressure switch trim 1 can be installed between pressure switch body 37 and pipeline 50 is shown. In some embodiments, pipeline 50 can comprise tee coupler 44 wherein pipeline 50 can be threaded into threaded openings 49 disposed on tee coupler 44, as well known to those skilled in the art. Valve 42 can be coupled to tee coupler 44 by threading threaded end 46 into threaded opening 48. In some embodiments, valve 42 can comprise a ball valve mechanism, which can be operated by turning handle 45 disposed thereon, as well known to those skilled in the art. In other embodiments, valve 42 can comprise any other functionally equivalent valve mechanism as well known to those skilled in the art including, but not limited to, globe valves, compression valves, butterfly valves, gate valves, choke valves, rising stem valves or non-rising stem valves. Ported bushing with integrated pressure switch trim 1 can be coupled to valve 42 by threading end threads 16 of valve end 7 into threaded opening 43. Pressure switch body 37 can then be coupled to ported bushing with integrated pressure switch trim 1 by threading pressure switch body 37 into threads 6 disposed on pressure switch end 5 forming pressure switch 36.

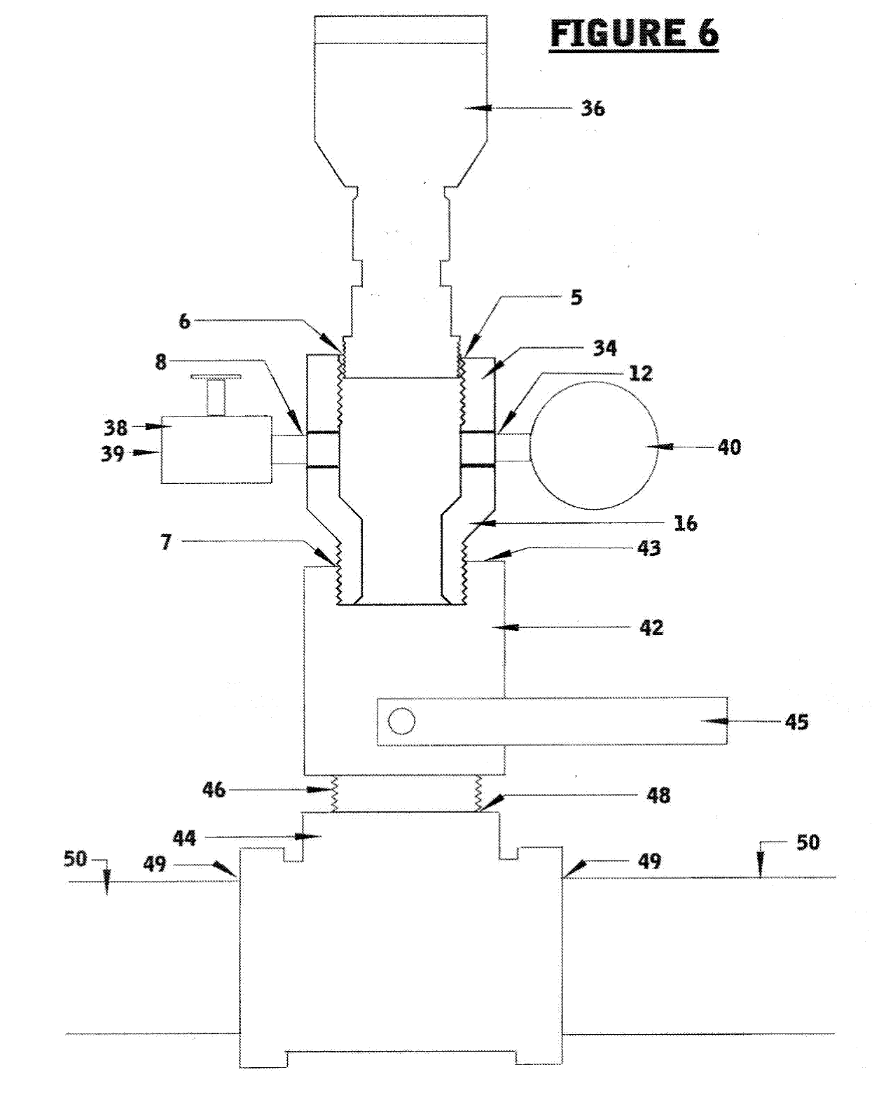

Referring to FIG. 6, an embodiment of how ported bushing 34 can be installed between pressure switch 36 and pipeline 50 is shown. In some embodiments, pipeline 50 can comprise tee coupler 44 wherein pipeline 50 can be threaded into threaded openings 49 disposed on tee coupler 44, as well known to those skilled in the art. Valve 42 can be coupled to tee coupler 44 by threading threaded end 46 into threaded opening 48. In some embodiments, valve 42 can comprise a ball valve mechanism, which can be operated by turning handle 45 disposed thereon, as well known to those skilled in the art. In other embodiments, valve 42 can comprise any other functionally equivalent valve mechanism as well known to those skilled in the art including, but not limited to, globe valves, compression valves, butterfly valves, gate valves, choke valves, rising stem valves or non-rising stem valves. Ported bushing 34 can be coupled to valve 42 by threading end threads 16 of valve end 7 into threaded opening 43. Pressure switch 36 can then be coupled to ported bushing 34 by threading pressure switch 36 into threads 6 disposed on pressure switch end 5.

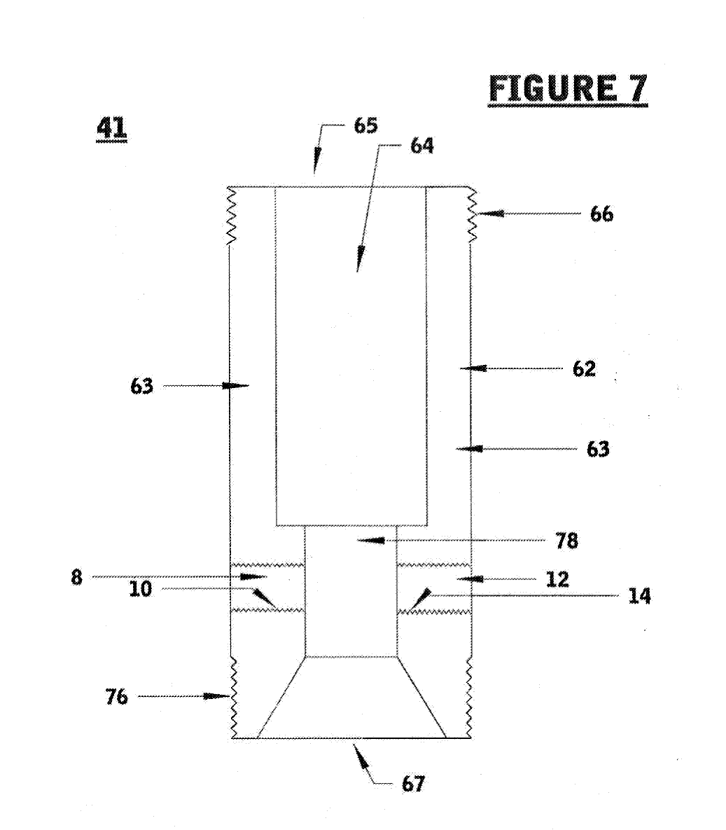

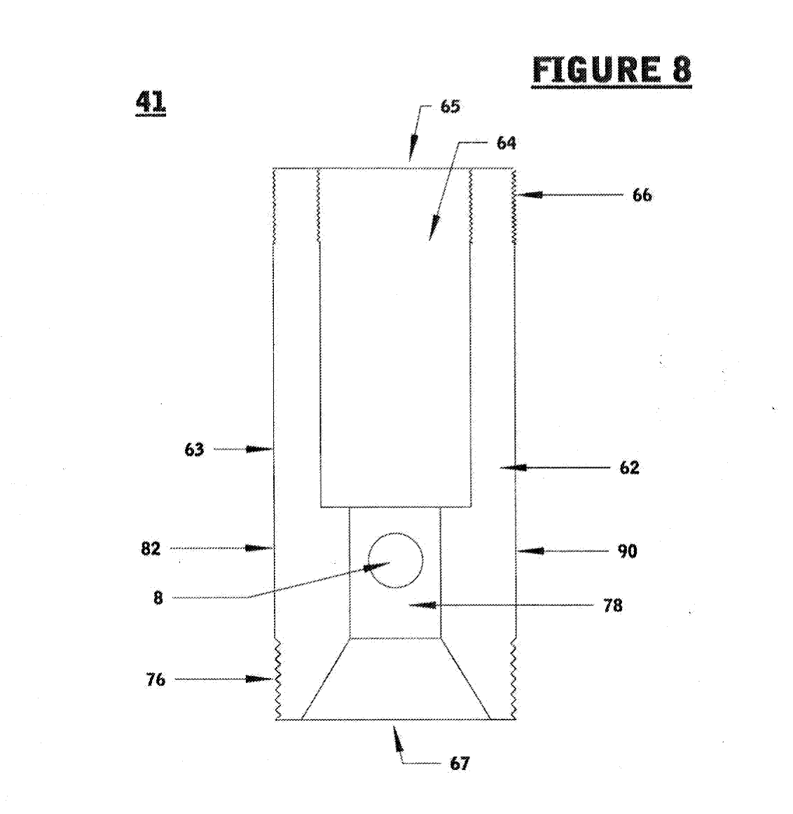

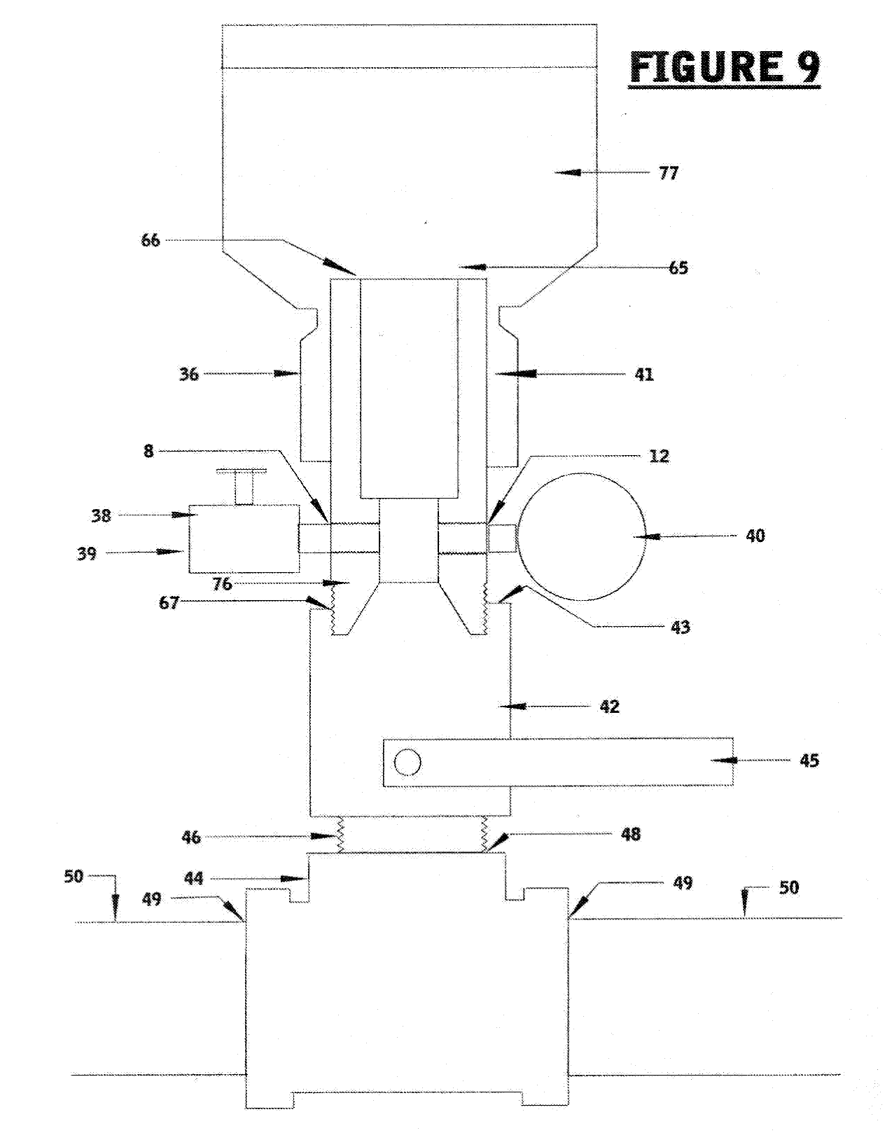

Referring to FIGS. 7 to 9, an alternate embodiment of a ported bushing integrated with, or otherwise further comprising, a pressure switch housing body, represented by reference numeral 41, is shown. In some embodiments, ported pressure switch housing body 41 can comprise sidewall 63 extending between pressure switch enclosure end 65 and valve end 67, with sidewall 63 extended in length such that main body 62 can form an integrated body housing capable of receiving a pressure switch enclosure 77, as shown in FIG. 9. Internal chamber 64 can further be configured to receive and house pressure switch components therein (not shown), and can be sealed or otherwise isolated from central passageway 78. Valve end 67 can be configured to provide communication to central passageway 78 and can allow fluids to pass thereto. Similar to the embodiment of ported bushing with integrated pressure switch trim 1 as shown in FIGS. 1 and 2, and the embodiment of ported bushing 34 as shown in FIGS. 3 and 4, ported pressure switch housing body 41 can comprise threads 66 for receiving a pressure switch enclosure 77, end threads 76 for coupling to a valve or fitting, and threaded test ports 8 and 12, further comprising threads 10 and 14 respectively, extending through sidewall 63 to provide communication with central passageway 78, and for receiving test equipment to test the operation of a pressure switch coupled to ported bushing with integrated pressure switch housing body 41.

In some embodiments, ported pressure switch housing 41 can further comprise substantially parallel flat surfaces 82 and 90 deposed on main body 62 for receiving a wrench to turn ported pressure switch housing body 41 into or out of a threaded fitting (not shown) as well known to those skilled in the art.

Referring to FIG. 9, an embodiment of how ported pressure switch housing body 41 can be installed between pressure switch enclosure 77 and pipeline 50 is shown. In some embodiments, pipeline 50 can comprise tee coupler 44 wherein pipeline 50 can be threaded into threaded openings 49 disposed on tee coupler 44, as well known to those skilled in the art. Valve 42 can be coupled to tee coupler 44 by threading threaded end 46 into threaded opening 48. In some embodiments, valve 42 can comprise a ball valve mechanism, which can be operated by turning handle 45 disposed thereon, as well known to those skilled in the art. In other embodiments, valve 42 can comprise any other functionally equivalent valve mechanism as well known to those skilled in the art including, but not limited to, globe valves, compression valves, butterfly valves, gate valves, choke valves, rising stem valves or non-rising stem valves. Ported pressure switch housing body 41 can be coupled to valve 42 by threading end threads 76 of valve end 67 into threaded opening 43. Pressure switch enclosure 77 can then be coupled to ported pressure switch housing body 41 by threading pressure switch enclosure 77 into threads 66 disposed on pressure switch end 65, thereby forming pressure switch 36.

In some embodiments, test equipment can be coupled to test ports 8 and 12 for testing the operation of pressure switch 36. This test equipment can include test valve 38 operatively coupled to one of test ports 8 and 12, and pressure gauge operatively coupled to the other of test ports 8 and 12. For illustrative purposes only, test valve 38 is shown coupled to test port 8 and pressure gauge 40 is shown coupled to test port 12 in FIGS. 5 and 6 although it is obvious that test valve 38 and pressure gauge 40 can be coupled to test ports 12 and 8, respectively. In some embodiments, test valve 38 can comprise a needle valve or a ball valve, or any other functionally equivalent valve mechanism as well known to those skilled in the art.

In normal operation, ported bushing with integrated pressure switch trim 1 or ported bushing 34 or ported pressure switch housing body 41 can have one or both of test valve 38 and pressure gauge 40 installed in test ports 8 and 12, wherein test valve 38 is closed or turned off. In other embodiments, ported bushing with integrated pressure switch trim 1 or ported bushing or ported pressure switch housing body 41 can simply have threaded plugs or bolts threaded into one or both of test ports 8 and 12 to close them off. In operation, test ports 8 and 12 would be closed off, either with plugs or with test valve 38 and pressure gauge 40 installed therein, and valve 42 would be open to allow fluids flowing through pipeline 50 to be in communication with pressure switch 36.

When pressure switch 36 is to be tested, valve 42 is closed by operating handle 45. If the ported bushing with integrated pressure switch trim 1 or ported bushing 34 or ported pressure switch housing body 41 only had plugs installed in test ports 8 and 12, the plugs can be removed and test valve 38 and pressure gauge 40 installed therein. A source of gas or fluid that can be pumped can be coupled to threaded opening 39 of test valve 38, which is initially closed. In some embodiments, a hand-operated pump, as well known to those skilled in the art, can be used to pump air or fluid from a reservoir or container. Test valve 38 can then be opened, and the pump can be operated to pump air or fluid into ported bushing with integrated pressure switch trim 1 or ported bushing 34 or ported pressure switch housing body 41 to increase the pressure of the gas or fluid that is in communication with pressure switch 36. Pressure gauge 40 can provide a visual pressure reading of the gas or fluid in the ported bushing as the pump is being operated. The pump can be operated to increase the pressure of the gas or fluid in communication with pressure switch 36 until the pressure exceeds the pressure threshold set on pressure switch 36 and operates the electrical switch contained therein. When pressure switch 36 operates, pressure gauge 40 can provide a pressure reading that can represent the pressure required to operate pressure switch 36. With this information, an operator can then determine whether the pressure threshold setting on pressure switch 36 is properly set in accordance with the specifications that pressure switch 36 is expected to operate under, or whether the threshold setting on pressure switch 36 needs to be adjusted to bring it in compliance with those specifications.

To return pressure switch 36 back to normal operation, test valve 38 can be closed and the pump removed therefrom. In some embodiments, one or both of test valve 38 and pressure gauge 40 can be removed from test ports 8 and 12, and have the plugs reinstalled. In other embodiments, one or both of test valve 38 and pressure gauge 40 can be left installed in test ports 8 and 12. Valve 42 can be opened to allow pressure switch 36 to monitor the pressure of fluids or gas flowing through pipeline 50.

While FIGS. 5, 6 and 9 illustrate valve 42 coupled directly to tee coupler 44, ported bushing with integrated pressure switch trim 1 or ported bushing 34 or ported pressure switch housing body 41 directly coupled to valve 42, and pressure switch 36 directly coupled to ported bushing with integrated pressure switch trim 1 or ported bushing 34 or ported pressure switch housing body 41, it is obvious to those skilled in the art that, in other embodiments, each of these components can be separated, but still remain operatively connected to one another, by other fittings, valves, sections of pipe or other pipeline equipment as well known to those skilled in the art.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

What is claimed is:

1. A ported bushing for a pressure switch configured for monitoring the pressure of hydrocarbons flowing through a pipeline, the ported bushing comprising:
a tubular main body further comprising first and second ends, and a sidewall thereby forming a central passageway between the first and second ends;
first attachment means for attaching the pressure switch to the first end;
second attachment means for attaching the second end to a first valve connected to the pipeline or directly to the pipeline; and
first and second ports disposed through the sidewall to provide communication to the central passageway, the first and second ports configured to operatively couple with test equipment configured for testing the operation of the pressure switch.

2. The ported bushing as set forth in claim 1, wherein the first and second attachment means further comprise threads configured for threadably coupling the main body to the pressure switch and to the first valve or to the pipeline.

3. The ported bushing as set forth in claim 1, further comprising two substantially parallel flattened surfaces disposed on the sidewall of the main body wherein a wrench can engage the flattened surfaces to rotate the main body.

4. The ported bushing as set forth in claim 1, further comprising at least one set screw disposed near the first end, the at least one set screw configured to secure the pressure switch to the main body when the pressure switch is operatively attached to the main body via the first attachment means.

5. The ported bushing as set forth in claim 1, wherein the first and second ports further comprise threads for operatively coupling to the test equipment.

6. The ported bushing as set forth in claim 1, wherein the tubular main body further comprises, or is integrated with, a pressure switch trim.

7. The ported bushing as set forth in claim 1, wherein the tubular main body further comprises, or is integrated with, a pressure switch housing body.

8. A system for testing a pressure switch configured for monitoring the pressure of hydrocarbons flowing through a pipeline, the system comprising:
a ported bushing, further comprising:
a tubular main body further comprising first and second ends, and a sidewall thereby forming a central passageway between the first and second ends,
first attachment means for attaching the pressure switch to the first end,
second attachment means for attaching the second end to a first valve connected to the pipeline, and
first and second ports disposed through the sidewall to provide communication to the central passageway, the first and second ports configured to operatively couple with test equipment configured for testing the operation of the pressure switch;
a test valve configured for operatively coupling to one of the first and second ports;
a pressure gauge configured for operatively coupling to the other of the first and second ports; and
the first valve configured for operatively coupling the second end to a tee coupler disposed on the pipeline.

9. The system as set forth in claim 8, wherein the first and second attachment means further comprise threads configured for threadably coupling the main body to the pressure switch and to the first valve, respectively.

10. The system as set forth in claim 8, further comprising two substantially parallel flattened surfaces disposed on the sidewall of the main body wherein a wrench can engage the flattened surfaces to rotate the main body.

11. The system as set forth in claim 8, further comprising at least one set screw disposed near the first end, the at least one set screw configured to secure the pressure switch to the main body when the pressure switch is operatively attached to the main body via the first attachment means.

12. The system as set forth in claim 8, wherein the first and second ports further comprise threads for operatively coupling to the test equipment.

13. The system as set forth in claim 8, wherein the tubular main body further comprises, or is integrated with, a pressure switch housing body.

14. The system as set forth in claim 8, further comprising the pressure switch.

15. A method for testing a pressure switch configured for monitoring the pressure of hydrocarbons flowing through a pipeline comprising a tee coupler disposed thereon, the method comprising the steps of:
providing a system for the testing the pressure switch, the system comprising:
a ported bushing, further comprising a tubular main body further comprising first and second ends, and a sidewall thereby forming a central passageway between the first and second ends, first attachment means for attaching the pressure switch to the first end, second attachment means for attaching the second end to a first valve connected to the pipeline, and first and second ports disposed through the sidewall to provide communication to the central passageway, the first and second ports configured to operatively couple with test equipment configured for testing the operation of the pressure switch,
a test valve configured for operatively coupling to one of the first and second ports,
a pressure gauge configured for operatively coupling to the other of the first and second ports, and
the first valve configured for operatively coupling the second end to a tee coupler disposed on the pipeline;
installing the system between the pressure switch and the tee coupler, wherein:
the first valve is operatively coupled to the tee coupler,
the ported bushing is operatively coupled to the first valve,
the test valve is operatively coupled to one of the of the first and second ports wherein the test valve is in communication with the central passageway, the test valve initially in a closed position,
the pressure gauge is operatively coupled to the other of the first and second ports wherein the pressure gauge is in communication with the central passageway, and
the pressure switch is operatively coupled to the ported bushing;
closing the first valve;
attaching a source of gas or fluid that can be pumped to the test valve and opening the test valve;
pumping the gas or fluid into the ported bushing wherein the pressure of the gas or fluid in the ported bushing increases until the pressure switch operates; and
reading the pressure gauge after the pressure switch operates to obtain a pressure reading displayed thereon.

16. The method as set forth in claim 15, wherein the first and second attachment means further comprise threads configured for threadably coupling the main body to the pressure switch and to the first valve.

17. The method as set forth in claim 15, wherein the system further comprises two substantially parallel flattened surfaces disposed on the sidewall of the main body wherein a wrench can engage the flattened surfaces to rotate the main body.

18. The method as set forth in claim 15, wherein the system further comprises at least one set screw disposed near the first end, the at least one set screw configured to secure the pressure switch to the main body when the pressure switch is operatively attached to the main body via the first attachment means.

19. The method as set forth in claim 15, wherein the first and second ports further comprise threads for operatively coupling to the test equipment.

20. The method as set forth in claim 15, wherein the tubular main body further comprises, or is integrated with, a pressure switch trim.

21. The method as set forth in claim 15, wherein the tubular main body further comprises, or is integrated with, a pressure switch housing body.
